(19) United States
(12) Patent Application Publication
(10) Pub. No.: US 2015/0178137 A1
(43) Pub. Date: Jun. 25, 2015

(54) DYNAMIC SYSTEM AVAILABILITY MANAGEMENT

(71) Applicant: MICROSOFT CORPORATION, Redmond, WA (US)

(72) Inventors: Stefan Keir Gordon, Redmond, WA (US); Jason Earl Ginchereau, Redmond, WA (US); Joshua Boehm, Seattle, WA (US)

(73) Assignee: MICROSOFT CORPORATION, Redmond, WA (US)

(21) Appl. No.: 14/138,744

(22) Filed: Dec. 23, 2013

(51) Int. Cl. G06F 9/50; H04L 29/08

(52) U.S. Cl. CPC G06F 9/5055; H04L 67/1008; H04L 67/101

(57) ABSTRACT

Server cluster management includes dynamically migrating machines between different server pools within the server cluster. The server pools include an active pool and at least one standby pool. Different standby pools can also be maintained to provide machines in different states of standby, including but not limited to different powered down or hibernation states. Machines are migrated between the different server pools based on network demands and machine status and capabilities. In some instances, the network demands are determined by forecasting future demands. The status and capability of the individual machines is evaluated on a continual basis to determine whether there is adequate capacity of the machines in the active pool to satisfy the one or more network demands, as well as to determine which machine is the most appropriate machine to migrate between server pools. Machines can also be migrated between the different standby pools.

### BACKGROUND

Computers and computing systems affect nearly every aspect of modern living. Computers are generally involved in work, recreation, health care, transportation, entertainment, household management, and so forth. Computing systems are providing increasingly complex and sophisticated functionality. Such functionality is often primarily driven by underlying software, which itself is becoming ever more complex. Application developers have the task of developing such software, and to tune its performance to ensure efficient and secure operation.

Some computing systems are configured as distributed cloud or cluster environments, wherein a plurality of networked machines are collectively provided to service client requests. Load balancers and routers are also provided to direct service requests to available computing resources within the distributed systems.

To enable efficient service, it is important to ensure that the underlying software is properly installed and that the machines are appropriately tuned and regularly updated. In gaming environments, for instance, it can be particularly important to install new game releases and other software updates onto each of the game servers within the network.

Updating a machine with the latest software or performing other maintenance typically requires the machine to be pulled offline for a period of time. Accordingly, maintenance procedures can sometimes have a negative impact on the system's capacity, which can thereby reduce bandwidth and degrade overall Quality of Service (QoS).

It will be appreciated that the subject matter claimed herein is not limited to embodiments that solve any of the foregoing disadvantages or that operate only in environments such as those described above. Rather, this background is only provided to illustrate exemplary technology areas where some embodiments described herein may be practiced.

### BRIEF SUMMARY

At least some embodiments described herein refer to systems for managing and dynamically migrating machines between different server pools in a server cluster. The server pools include an active pool and at least one standby pool. Machines in the active pool are immediately available to be connected to clients in network sessions. In contrast, machines in the at least one standby pool are temporarily unavailable for network sessions with clients until they are migrated into the active server pool.

In some embodiments, machines in the active pool operate as stateful machines, such that at least some of the machines in the active pool will be connected to clients in corresponding stateful sessions. The stateful sessions are lengthy network connections that will be negatively affected by switching the hosting server during the network session. In some embodiments, the lengthy stateful sessions involve gaming or streaming of multimedia content.

Implementation of the claimed invention includes monitoring network demands, including client requests. In some instances, the network demands are determined by forecasting future demands. The status and capability of the individual machines in the networked cluster are also evaluated, including machines in the active server pool, to determine whether there is adequate capacity of the machines in the active pool to satisfy the one or more network demands.

When there is adequate capacity, a particular one or more of the first set of machines in the active pool will be assigned to satisfy the one or more network demands. Selection of a particular machine to meet the network demands can be intelligently based on an analysis of the particular machine status and capability relative to the status and capability of another machine in the active pool, therefore ensuring that a most appropriate machine is selected.

When the network demand corresponds to a client request for network services, the selected machine will be assigned to provide those services. However, when the network demand corresponds to a need for tuning, upgrading or other system maintenance, then the selected machine is removed from the active pool and transitioned into a standby pool.

In some embodiments, the migration of machines between the active pool and at least one standby pool includes enqueuing the machines for migration and then, subsequent to the enqueuing but prior to dequeuing the machines into another server pool, performing a separate validation to ensure there is adequate or excess machine capacity within the active pool. Whenever the active pool fails to have adequate or excess capacity a machine can be moved into the active pool from a standby pool to ensure that the active pool retains sufficient capacity to meet the system's needs.

As machines are updated within a standby pool, they can be alternated with other machines in the active pool to facilitate the updating of different machines. Different standby pools can also be maintained to provide machines in different states of standby, including but not limited to different powered down or hibernation states. Machines can also be migrated between the different standby pools.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates a computing environment with different machines residing in different server pools, including an active server pool and at least one standby server pool;

FIG. 3 illustrates a flowchart corresponding to exemplary methods for managing machines in a server cluster between different server pools;

FIG. 4 illustrates a flow diagram of machines being migrated between different server pools and server states; and

FIG. 5 illustrates a flowchart corresponding to other methods for managing machines in a server cluster between different server pools.

### DETAILED DESCRIPTION

At least some embodiments described herein refer to methods, systems, and storage media configured for managing and dynamically migrating machines between different server pools in a server network. The server network can be any grouping of servers or machines that are networked together, including server clusters, clouds, farms, and other configurations.

The terms machine and server are sometimes used interchangeably herein, particularly wherein the machine or server is a virtual entity. However, it will be appreciated that a machine and a server can also be a physical computer. In this regard, a single machine or server can actually host a plurality of corresponding servers or software machines, wherein at least one of the hosted servers/machines resides within the active pool and at least one of the hosted servers/machines resides within one of the standby pools.

It will also be appreciated, therefore, that the boundaries between the active pool and the standby pool(s) can be physical boundaries and/or virtual boundaries.

As described herein, the managed server pools include an active pool and at least one standby pool, wherein machines in the active pool are machines that are immediately available to be connected to clients in network sessions, and wherein machines in the at least one standby pool are at least temporarily unavailable to be connected to clients in network sessions. The degree of unavailability will depend on the type of standby pool where the machine is located, such as a hibernation pool, a powered down pool, and so forth. The server pools can also include one or more upgrading server pool(s) containing machines that are undergoing one or more maintenance procedures, such as software upgrades or hardware upgrades.

The machines in the different server pools and the server pools themselves have different states corresponding to different bring up times. For instance, a hibernation standby pool has a shallow or hot standby state corresponding to a quick load or short bring up time, whereas a powered down standby pool has a deep standby state corresponding to a slower boot up time. An upgrading server pool is a particular type of standby pool in which the servers in the upgrading server pool have an upgrading state, which can require even more downtime to allow for the upgrade or update.

As previously noted, machines in the active pool operate as stateful machines connected to clients in corresponding lengthy and stateful sessions. These stateful sessions can be continuous and high throughput sessions, such as gaming sessions or media streaming sessions that are low latency and unable to accommodate migration of state between different hosting server machines without causing noticeable glitches or other QoS degradation.

One way to help minimize such QoS degradation is intelligent management of the server machines between the different server pools described herein by dynamically migrating the server machines between standby states, upgrade states, and active states as loads against the network services change. Updates are also applied to the machines when it is determined there is sufficient capacity and need within the system. When system availability falls below a target capacity, for instance, machines are moved from a standby state (e.g., shallow or hot standby, deep standby, powered off standby) to an active state. Similarly, when desired load is below current capacity, machines are moved from an active pool and state to an appropriate standby pool and standby state. Machines can also be moved between different standby pools having different standby states. Load estimation algorithms are used to predict future need and influence the scheduling of updates in order to maintain target capacity levels in the active pool and one or more standby pools.

The status and states of the different machines and the network demands are monitored and evaluated on a continuous, frequent, or at least predetermined periodic basis to ensure that the migration of the machines between the different server pools is justified according to a cost/benefit analysis.

The frequency of the monitoring can occur on a continuous loop, on a scheduled periodic frequency (e.g., every few seconds, every few minutes, every few hours, a specific time of day, etc.), on demand and/or in response to a detected condition (e.g., a detected influx of network traffic, a detected system failure, a detected weather pattern, a detected sporting or news event, and so forth).

The server pools are generally allocated so that they are able to meet the rate of requests against consuming clients such as, for example, end users. The ratio between the users/servers can vary widely depending on the application, but is generally a metric of interest as it has great implication on both the cost and quality of the service. The greatest efficiency is reached when the number of active servers just meets the request rate from clients without any degradation of experience.

Existing systems that are designed to maximize efficiency are typically unable to take an update and serve client requests at the same time without degrading QoS because their limited number of servers will be occasionally taken out of service during the updating process. Alternatively, they are overdesigned with too many servers for regular demands. To address these problems, some systems provide load balancers that can maintain a desired capacity of active servers at any given time to accommodate anticipated demands. However, no existing systems actively monitor the specific states and status of each of a plurality of individual machines on a periodic or continual basis to determine which of the plurality of machines will be the most appropriate to migrate from one server pool to another, as do the server pool and server state supervisor systems of the present invention.

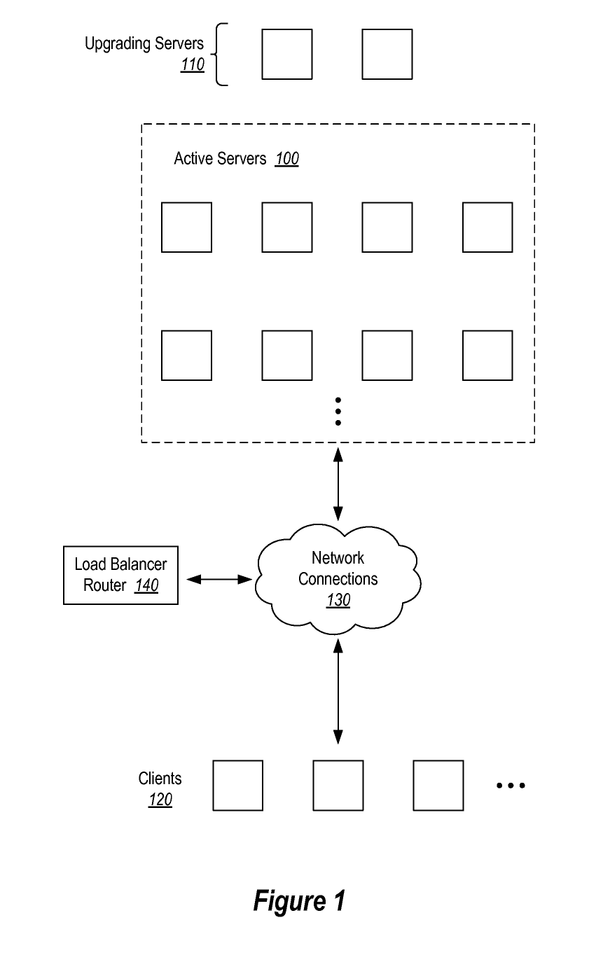

FIG. 1, for instance, illustrates a system in which a network of servers includes a plurality of active servers 100 and servers that are being upgraded 110. The active servers 100 communicate with clients 120 through one or more network connections 130 that are controlled, at least in part, by a load balancer/router 140 that dictates which servers the client requests are routed to.

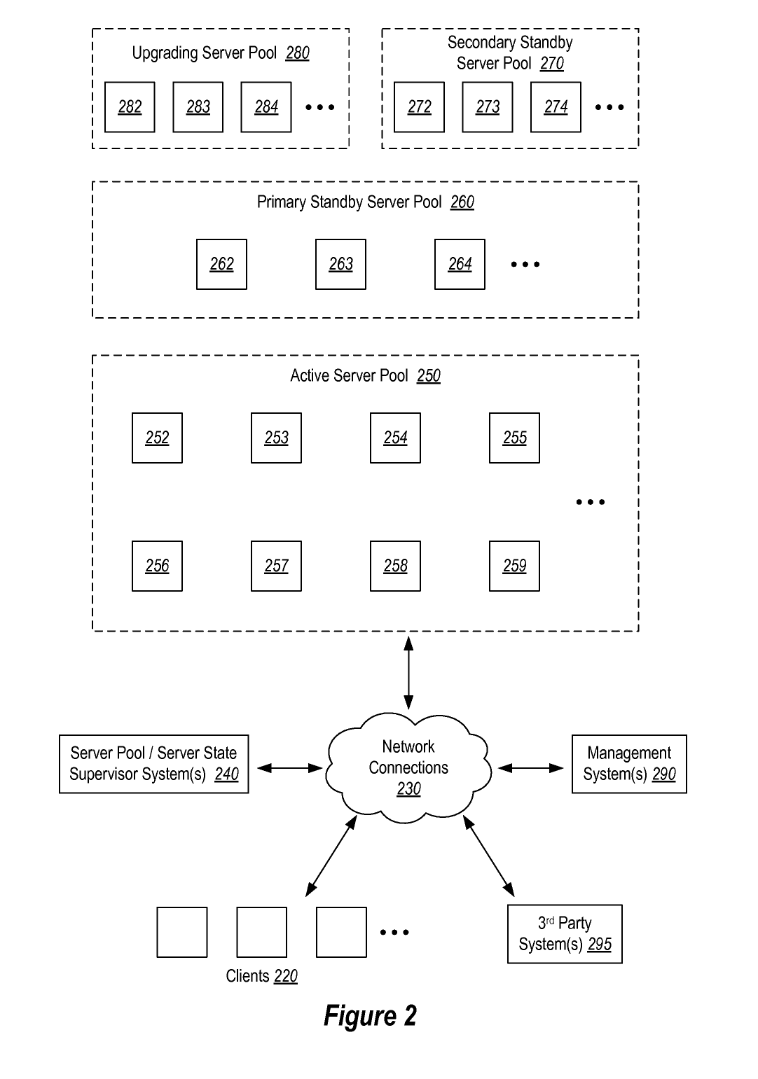

When the load balancer 140 is configured with the software modules of the present invention, the active servers 100 are organized into a plurality of discrete server pools, as reflected in FIG. 2. The load balancer 140, when configured like known load balancers, will only route client requests according to current loads detected by the different active servers and/or in response to a round-robin routing scheme. Alternatively, the load balancer 140 will simply route requests for an ongoing active network session to the active server(s) maintaining the state for that active, ongoing network session.

An improved management system is reflected in FIG. 2, wherein the load balancer 140 of FIG. 1 is replaced by one or more intelligent server pool/server state supervisor system(s) 240. The supervisor system(s) 240 can comprise a stand-alone or distributed computer system with one or more hardware processors and system memory or other hardware storage medium that have stored computer-executable instructions for implementing the functionality of the described methods of the invention.

The computing environment shown in FIG. 2 also reflects a plurality of discrete server pools, including an active server pool 250, a primary standby server pool 260, a secondary standby server pool 270 and an upgrading server pool 280. The servers/machines 252-259 in the active server pool 250 are configured in an active state so that they are immediately available to service any incoming client requests. The servers/machines 262-264, in the primary standby server pool 260 have a first standby state which makes them unavailable to immediately service client requests. Servers/machines 272-274, in a secondary standby server pool 270, also have a standby state which makes them unavailable to immediately service client requests. Finally, servers/machines 282-284, in upgrading server pool 280, also have a standby state that makes them unavailable to immediately service client requests.

It will be appreciated that the standby states of the servers in the various server pools 260, 270 and 280 can be the same or different according to different embodiments, as described in more detail below. Likewise, there can be any number of standby pools (e.g., 1, 2, 3, 4, or even more), as well as any quantity of machines in each standby pool, to differ from what is currently illustrated.

When an incoming request is received by the supervisor system(s) 240, the request is routed to the most appropriate server configured to satisfy that client request. In some instances, this includes verifying that the server has appropriately loaded software to satisfy the client request, such as the latest version of the software. The supervisor system(s) 240 can also verify that the server has the appropriate client state information and session state information for existing session requests. Verification of the current processing load and capacity of the server can also occur prior to routing the client request(s).

Unlike existing systems, the supervisor system(s) 240 of the present invention perform a regular inventory analysis of the different servers to determine which servers are the most appropriate servers to satisfy client requests, as well as to determine when it is most appropriate to migrate the servers between the different server pools 250, 260, 270 and 280, sometimes even independently of specific client requests.

The supervisor system(s) 240 will determine when it is most appropriate to migrate the servers between the different server pools based on a cost/benefit analysis of different information received from the network servers, including the specific state information for each of the individual server machines (e.g., any combination of current load, currently loaded software, existing client sessions, the amount of time since a maintenance or anti-malware program was run, health information, or current activities that must be completed before being dropped from rotation). Doing so can help to avoid any degradation in QoS, loss of cached client information, and other similar state and status information.

Notably, the supervisor system(s) 240 will evaluate the server state information for servers in the active pool 250, as well as the other pools 260, 270 and 280, since the evaluated server states can be used to determine when to move a server between any of the server pools, not only the active and update pools. For instance, a determination can be made to move a server between two different standby pools or between a standby pool and the upgrading server pool 280 (which can also be viewed as a particular type of a standby pool).

The supervisor system(s) 240 will also identify and consider information received from management system 290, such as rollout information that specifies the date of an anticipated software rollout, the amount of time it will take to perform an upgrade or other maintenance procedure, QoS requirements, or other management information.

Information obtained from third party system(s) 295 can also be identified and weighed in the consideration of when it is most appropriate to move one or more servers between different server pools. This third party information can include current event data (e.g., power outages, transportation reports, or client interest in games or political events that could potentially have an effect on social media and network traffic).

In contrast to known server management systems that simply provide a single active pool of servers and a single inactive pool of servers, the present invention provides a plurality of different types of standby server pools that are each associated with a different standby state to improve the efficiency of moving different servers from an inactive state to an active state and to reduce overall processing and upgrading costs. The different standby states can include a shallow standby state, such as a hibernation state maintained by the primary standby server pool 260, as well as a deep standby state, such as a powered down or deep hibernation state in which one or more server applications have been turned off, as in the secondary standby server pool 270. There may also be a separate upgrading state associated with servers in an upgrading server pool 280, which is different than the other standby states and in which a server is downloading a new software program, updating existing software, uninstalling software, receiving a hardware exchange and/or any other maintenance processes. Differences between the different standby/upgrade states and server pools can correspondingly affect the amount of time required to place the servers in those pools into an active state within the active server pool.

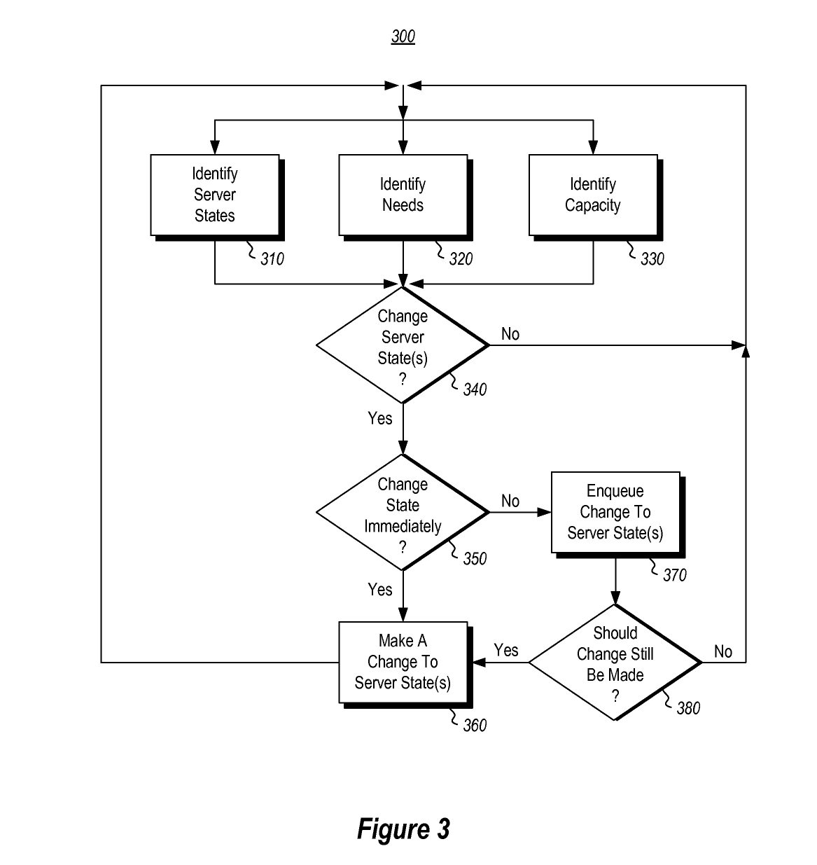

Certain methods of the invention will now be described with reference to the flow diagram of FIG. 3. As shown, methods of the invention can include the identification of the individual server states (310), the identification of client and/or network needs (320), and the current capacity (330) of the individual servers.

It will be appreciated that the server state information can be obtained through a push or pull system by using agents installed at the individual servers and/or at the supervisor system(s) 240. The server state information can include any information associated with a particular server, including current hardware and software configurations, current processing loads and tasks, cached data, and health status, as well as any of the other state and status information described herein that can be used to identify the status and capability of each of the different servers.

The needs of the system, which are also referred to herein as demands, can include individual needs corresponding to a particular client, a particular type or grouping of clients, and/or administrative needs. The administrative needs can include, for instance, a need for maintaining specific QoS requirements (e.g., latency, bandwidth, redundancy, etc.), hardware safety and warranty regulations (e.g., temperature limits, processing limits, etc.), maintenance scheduling, data analytics, and so forth.

The evaluated capacity can be based on the collective capacity of server network or the more limited capacity for one or more of the server pools (e.g., the active pool, the upgrade pool or a standby pool). The evaluated capacity can also be based on a particular quantity of machines or available bandwidth corresponding to a particular QoS, software configuration, hardware configuration, and/or any other capacity designation.

Notably, the evaluated states, needs and capacities can correspond exclusively to existing states, needs and capacities, as well as anticipated needs and capacities. Anticipated needs and capacities can also be based on historical data. For instance, various analytics algorithms can be applied to predict anticipated needs and capacities provided a given set of anticipated circumstances in view of historical precedent.

The supervisor system(s) evaluate the identified state data, need data and capacity data to determine whether a change in state of one or more servers should occur (340). This determination relates to whether a server should be moved from one server pool to another server pool, as well as which server is the most appropriate server to move. Accordingly, the determination as to whether a change needs to be made in a server state (340), can be based on an analysis of the received state/need/capacity information, which includes the status and capabilities of each of the different machines in at least the active pool, and sometimes the status and capabilities of each of the machines in the standby pool(s) as well.

For instance, the supervisor system evaluates the status and capability of each of the different servers relative to existing and/or anticipated network needs/demands to determine whether a server should be moved from one server pool to another server pool, thereby changing that server's state. The change can include changing from an active state in the active pool to an inactive state in a standby pool or an upgrading server pool (e.g., changing to a hibernated state, a powered down state, an upgrading state, etc.). The change in state can also include changing from a first inactive state to another inactive state or from an inactive state to an active state by moving the server between any of the corresponding standby server pools, as described above.

After determining whether a change in server state should occur (340), a determination is also made about whether the change should take place immediately (350) or whether the change should be queued up for a change at a later time (370). If the change should be made immediately, the change is made by migrating the server to a different server pool (360). This can occur physically by moving the server hardware (e.g., moving the server hardware to a different rack location) and/or virtually by remapping the server into a different server pool space.

Changing the server state can also include modifying a boot, hibernation, software activity, or other server status to comply with the state of the server pool where the server has migrated. For instance, if a server is migrated from an active state to a primary standby pool (260), the server might be transitioned into hibernation. Similarly, a server migrating from the primary standby pool (260) to the secondary server pool (270) can have an application and/or the operating system can be powered down. Migrating the server to an upgrading server pool can include initiating a maintenance procedure on the server.

Data structures, such as tables, arrays and indexes, are used by the supervisor system(s) 240 to track which servers are in the different server pools. In some instances, a separate data structure is used for each of the different server pools. In other instances, a single data structure is used to track which servers are assigned to the different fields. These data structures can include various fields that index and reflect the state and capability information of the different servers, as well as fields that reflect the location or server pool domain for each of the servers. As new information is obtained, the data structures are updated.

It will be appreciated that even when it is determined that a change should occur, it may take some time to affect the change. During this delay, it is possible for the underlying circumstances to change. Accordingly, in some embodiments the system also verifies whether a change should still be made (380) after the change is enqueued. This can include verifying whether any change should be made or whether the change should be made with the particular machine that was initially queued up for migration, rather than another machine.

It will also be appreciated that the process of obtaining the relevant state/need/capacity information will be continuous and iteratively performed at a predetermined schedule (e.g., a continuous loop, every few seconds, every few minutes, or on a less frequent schedule).

In some embodiments, different information is obtained at different interval frequencies depending on a user's needs and preferences. For instance, rollout information can be queried or considered every few hours or days, much less frequently than the querying and considering the existing system capacity in a particular pool every few minutes.

A few examples will now be provided to illustrate some of the functionality provided by the methods and systems of the current invention.

In the first example, a server cluster has ten servers and requires six to be active to meet a current load at 5 p.m. on Friday. Accordingly, servers 1-6 are active (in the active pool) and servers 7, 8, 9 & 10 are in standby (in a standby pool with a standby state, such as hibernation or another standby state that prevents these servers from servicing client requests). Past trends are identified that indicate Friday evening shows a spike in traffic to the site. Accordingly, the system prepares for the spike by moving servers 7 and 8 from standby to active prior to the spike to maintain the expected availability.

In another example, the server cluster again requires six servers to be active to meet the current load. Accordingly, servers 1-6 are active and servers 7, 8, 9 & 10 are in standby. However, servers 2 and 3 fail, dropping system capacity below desired levels and degrading system QoS. The system identifies the failure and responsively moves servers 7 and 8 from standby to active to maintain the expected availability.

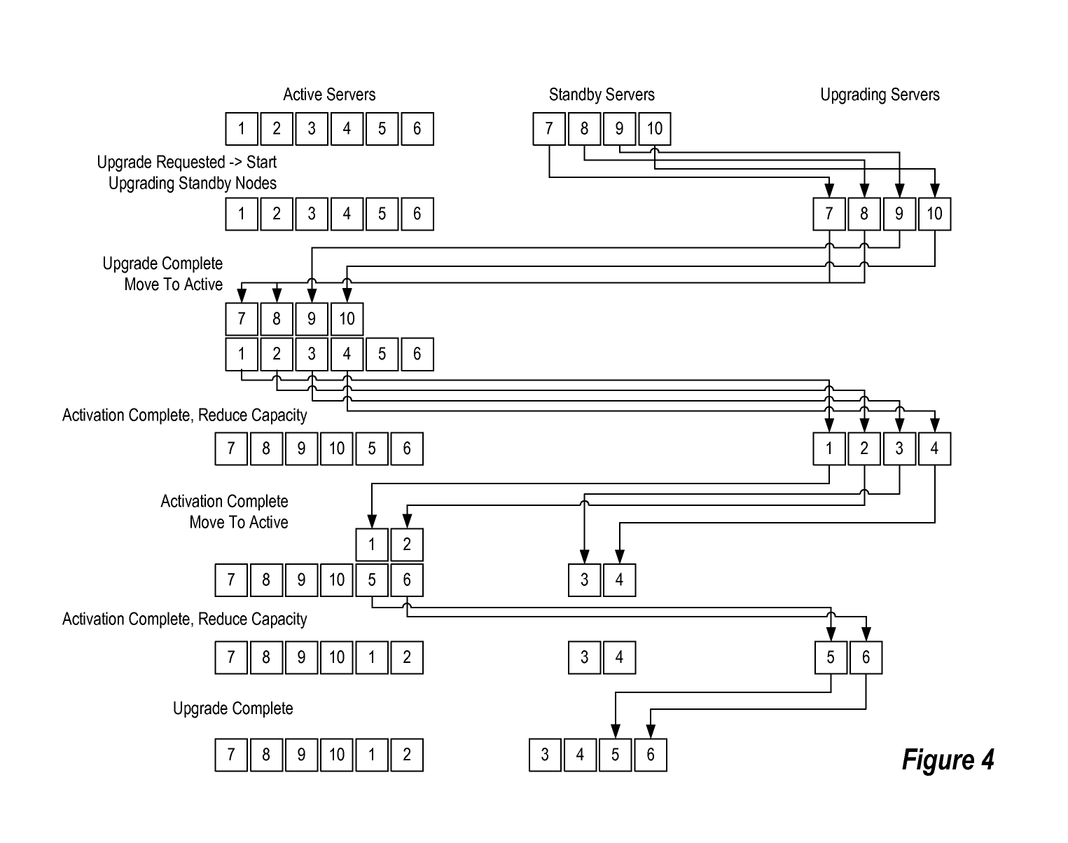

The third example will now be provided with reference to FIG. 4. As shown, a server cluster includes ten servers, six of which are required to be active to meet a current load at 2 p.m. on Friday. Accordingly, servers 1-6 are assigned to the active pool and servers 7, 8, 9, 10 are assigned to one or more standby pools. The system obtains information that a software update is to be applied to all of the servers. However, capacity is expected to remain steady for the next three hours, and so servers 7, 8, 9, 10 (which are already in standby) are upgraded. This may include moving servers (7, 8, 9 and/or 10) from one standby pool (e.g., the standby server pools 260 or 270 of FIG. 2) to another standby pool (e.g., the upgrading server pool 280 of FIG. 2).

When an upgrade completes on any single server, that server is then moved from the standby state to an active state by moving that server into the active pool. For example, once server 7 is moved to active (from upgrading) and taking traffic, server 1 will be transitioned to an upgrade state and the upgrade will begin on server 1 in the upgrade pool. The same thing happens for servers 8, 9 and 10 (with servers 2, 3, 4 being moved to the upgrade pool for updating) as reflected.

After upgrades complete for servers 1 and 2 they are moved back to active. Servers 3 and 4, however, are transitioned into a standby state in a standby pool.

Thereafter, servers 5 and 6 are moved to the upgrade state and updated accordingly. Finally, after all upgrades are completed, servers 5 and 6 are put into one or more standby pools. If it is anticipated that additional capacity will be needed, servers 5 and 6, for example, can be moved to a shallow standby state (e.g., hibernate) with servers 3 and 4 in a primary standby pool. Alternatively, if it is not anticipated that additional capacity will be needed in the immediate future, servers 5 and 6 can be put into a deep standby state (e.g., powered down) in a secondary standby pool.

It will be appreciated that the foregoing examples illustrate how the various server machines can be upgraded and migrated without affecting system capacity and while also improving efficiency and reducing the processing costs associated with maintaining extra server inventory.

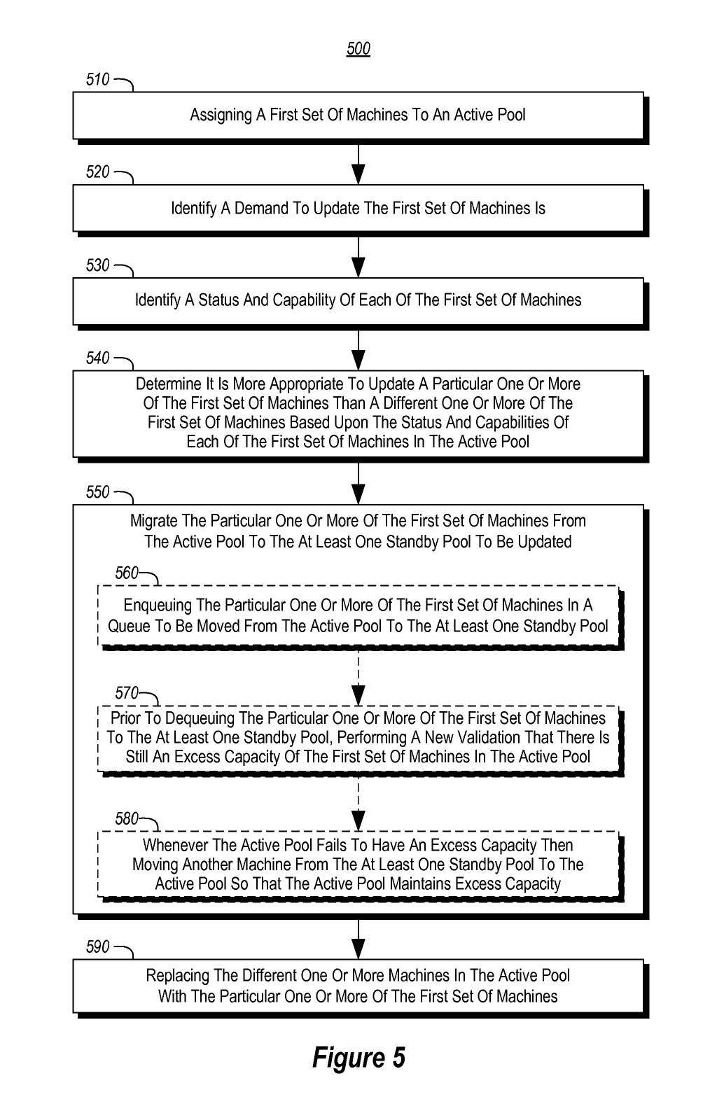

Another exemplary embodiment is illustrated in FIG. 5. As shown, FIG. 5 includes a flowchart 500 of acts that can be performed to facilitate managing and dynamically migrating a finite quantity of machines between different server pools in a server cluster. As before, the plurality of server pools includes an active pool and at least one standby pool, wherein machines in the active pool are machines that are available to be connected to clients in network sessions and wherein machines in the at least one standby pool are unavailable to be connected to clients in network sessions.

The illustrated method includes assigning a first set of machines to an active pool (510), wherein at least one of the first set of machines in the active pool operates as a stateful machine that is connected to at least one client in a lengthy and stateful session.

Then a demand to update the first set of machines is identified (520), as well as a status and capability of each of the first set of machines (530). It is then determined whether it is more appropriate to update the particular one or more of the first set of machines than a different one or more of the first set of machines based upon the status and capabilities of each of the first set of machines in the active pool (540).

The particular one or more of the first set of machines is then moved or migrated from the active pool to the at least one standby pool to be updated (550) by at least enqueuing the particular one or more of the first set of machines in a queue to be moved from the active pool to the at least one standby pool (560). Then, prior to dequeuing the one or more of the first set of machines to the at least one standby pool, a new validation is performed (570) to ensure that there is still an excess capacity of the first set of machines in the active pool. Notably, whenever the active pool fails to have an excess capacity then another machine is moved/migrated from the at least one standby pool to the active pool so that the active pool maintains excess capacity (580).

Finally, the particular machine that has been moved into the at least one standby pool (e.g., the updating server pool) will then be updated or upgraded by having any desired maintenance process performed on that particular machine (e.g., software update, hardware upgrade, reformatting, and so forth).

One or more different machines from one of the standby pools can also be subsequently or simultaneously added to the active pool to replace the machines that were migrated out of the active pool.

In summary, embodiments of the present invention can help improve the efficiency of some server clusters by intelligently managing the quantity of servers in the active server pool and one or more standby and/or upgrade server pools. Efficiency can be improved by intelligently rotating the servers between the different standby pools based on information identified while continuously monitoring the states and status of the individual machines, as well as other management and third party information.

This dynamic allocation of machines allows for zero downtime during upgrades, as well as reducing operational cost by keeping fewer machines that remain in an active state or even certain standby states. For example, the system can conserve energy by moving machines from a first hibernate state to a powered down state, when appropriate, but while still maintaining enough machines in a shallow hibernate state to quickly adjust to fluctuations in current needs. By tracking current and historic trends, the system can anticipate demand patterns and adjust the size of any of the server pools to maintain an optimal distribution of resources in each of the pools.

Although the subject matter has been described in language specific to structural features and/or methodological acts, it is to be understood that the subject matter defined in the appended claims is not necessarily limited to the described features or acts described above nor their order of presentation. Rather, the described features and acts are disclosed as example forms of implementing the claims.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor and a physical and tangible memory capable of having thereon computer-executable instructions that may be executed by the processor. A computing system may be distributed over a network environment and may include multiple constituent computing systems.

In its most basic configuration, a computing system typically includes at least one processing unit (such as a hardware processor) and memory. The memory may be a physical system memory, which may be volatile, nonvolatile, or some combination of the two. The term “memory” may also be used herein to refer to nonvolatile mass storage, such as physical storage media. If the computing system is distributed, the processing, memory and/or storage capability may be distributed as well.

As used herein, the term “executable instruction” can refer to software objects, routings, or methods that may be executed on the computing system. The different components, modules, engines, and services described herein may be implemented as objects or processes that execute on the computing system (e.g., as separate threads).

The described acts of the invention are implemented in software by one or more processors of the associated computing system that perform the act in response to having executed computer-executable instructions. The computer-executable instructions may be embodied on one or more computer-readable media that form a computer program product. An example of such an operation involves the manipulation of data. The computer-executable instructions (and the manipulated data) may be stored in the memory of the computing system. The computing system may contain any number of communication channels that allow the computing system to communicate with other message processors over, for example, a computing network.

Embodiments of the invention may comprise or utilize a special-purpose or general-purpose computer system that include computer hardware, such as, for example, one or more processors and system memory. The system memory may be included within the system memory. The system memory may also be referred to as “main memory”, and includes memory locations that are addressable by the at least one processing unit over a memory bus, in which case the address location is asserted on the memory bus itself. System memory has been traditionally volatile, but the principles described herein also apply to circumstances in which the system memory is partially, or even fully nonvolatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage, other magnetic storage devices, or any other hardware storage device(s) that can be used to store program code in the form of computer-executable instructions or data structures, which can be accessed and executed by a general-purpose or special-purpose computer system to implement the disclosed functionality of the invention.

Transmission media can include a network and/or data links that can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired and wireless) to a computer system, the computer system may view the connection as transmission media. Combinations of the above should also be included within the scope of computer-readable media.

Furthermore, upon reaching various computer system components, program code in the form of computer-executable instructions or data structures can be transferred automatically from transmission media to computer storage media (or vice versa). For example, computer-executable instructions or data structures received across a network or data link can be buffered in RAM within a network interface module (e.g., an “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries or intermediate format instructions, such as assembly language, or even source code.

Those skilled in the art will appreciate that the principles described herein may be practiced in network computing environments with many types of computer system configurations, including personal computers, desktop computers, laptop computers, message processors, handheld devices, multiprocessor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network both perform tasks. As such, in a distributed system environment, a computer system may include a plurality of constituent computer systems. In a distributed system environment, program modules may be located in both local and remote memory storage devices.

The present invention may be embodied in other specific forms without departing from its spirit or essential characteristics. The described embodiments are to be considered in all respects only as illustrative and not restrictive. For instance, those skilled in the art will appreciate that the invention may be practiced in a cloud computing environment. Cloud computing environments may be distributed, although this is not required. When distributed, cloud computing environments may be distributed internationally within an organization and/or have components possessed across multiple organizations. In this description, cloud computing is defined as a model for enabling on-demand network access to a shared pool of configurable computing resources (e.g., networks, servers, storage, applications, and services). However, the definition of cloud computing is not limited to any of the other numerous advantages that can be obtained from such a model when properly deployed. Accordingly, the scope of the invention is, therefore, indicated by the appended claims rather than by the foregoing description. All changes that come within the meaning and range of equivalency of the claims are to be embraced within their scope.

What is claimed:

1. A computer storage device having stored computer-executable instructions which, when executed by at least one processor, implement a method for managing and dynamically migrating a finite quantity of machines between different server pools in a server cluster, the plurality of server pools including an active pool and at least one standby pool, wherein machines in the active pool are machines that are available to be connected to clients in network sessions and wherein machines in the at least one standby pool are unavailable to be connected to clients in network sessions, the method comprising:
assigning a first set of machines to an active pool, wherein at least one of the first set of machines in the active pool operates as a stateful machine that is connected to at least one client in a lengthy and stateful session;
determining one or more network demands; and
determining whether there is adequate capacity of the first set of machines in the active pool to satisfy the one or more network demands by at least evaluating a status and capability of each of the first set of machines; and
upon determining there is adequate capacity of the first set of machines to satisfy the one or more network demands, based at least upon the evaluated status and capability of each of the first set of machines, selecting a particular one or more of the first set of machines to satisfy the one or more network demands; and
upon determining there is excess capacity of the first set of machines in the active pool, based at least upon the evaluated status and capability of each of the first set of machines and the network demands, moving one or more of the first set of machines from the active pool to the at least one standby pool.

2. The storage device of claim 1, wherein the method further includes moving an additional one or more machines from the active pool to the at least one standby pool whenever it is determined that there is excess capacity of the first set of machines in the active pool beyond a predetermined threshold of excess capacity based upon the evaluated status and capability of each of the first set of machines.

3. The storage device of claim 1, wherein determining there is adequate capacity includes first determining that there is insufficient capacity of the first set of machines in the active pool to satisfy the one or more network demands and thereafter moving one or more machines from the at least one standby pool to the active pool.

4. The storage device of claim 1, wherein the one or more network demands comprises a client request and wherein upon determining there is adequate capacity of the first set of machines to satisfy the client request for a corresponding client, assigning a particular machine from the first set of machines in the active pool to a persistent and stateful session between the particular machine and the corresponding client for an extended duration of time while the client request is being satisfied.

5. The storage device of claim 1, wherein the one or more network demands comprises a demand to update the first set of machines, and wherein selecting a particular one or more of the first set of machines to satisfy the one or more network demands includes determining it is more appropriate to update the particular one or more of the first set of machines than a different one or more of the first set of machines based upon the status and capabilities of each of the first set of machines in the active pool, and wherein the method further includes moving the particular one or more of the first set of machines from the active pool to the at least one standby pool to be updated.

6. The storage device of claim 1, wherein determining the one or more network demands includes anticipated future demands and wherein the method includes forecasting the future demands based on historical patterns.

7. The storage device of claim 1, wherein determining the one or more network demands includes future demands and wherein the method includes forecasting the future demands based on an anticipated software rollout.

8. The storage device of claim 1, wherein determining the one or more network demands includes hardware maintenance demands.

9. The storage device of claim 8, wherein the hardware maintenance demands include temperature regulation of machine hardware.

10. The storage device of claim 1, wherein evaluating the status and capability of each of the first set of machines includes identifying a current status of utilization of each of the first set of machines.

11. The storage device of claim 1, wherein evaluating the status and capability of each of the first set of machines includes identifying a current health status of each of the first set of machines.

12. The storage device of claim 1, wherein evaluating the status and capability of each of the first set of machines includes identifying a current location of each of the first set of machines.

13. The storage device of claim 1, wherein evaluating the status and capability of each of the first set of machines includes identifying a current temperature status of each of the first set of machines.

14. The storage device of claim 1, wherein evaluating the status and capability of each of the first set of machines includes identifying a current age status of each of the first set of machines.

15. The storage device of claim 1, wherein evaluating the status and capability of each of the first set of machines includes identifying a current status of updates of each of the first set of machines.

16. The storage device of claim 1, wherein moving the one or more of the first set of machines from the active pool to the at least one standby pool includes:
enqueuing the one or more of the first set of machines to be moved from the active pool to the at least one standby pool; and
performing a validation that there is still an excess capacity of the first set of machines subsequent to enqueuing the one or more of the first set of machines and prior to dequeuing the one or more of the first set of machines to the at least one standby pool.

17. The storage device of claim 1, wherein the at least one standby pool includes more than two standby pools.

18. The storage device of claim 16, wherein the at least one standby pool includes a first standby pool that maintains machines in a powered down mode and wherein at least a second standby pool maintains machines in a powered up mode.

19. A computer-implemented method for managing and dynamically migrating a finite quantity of machines between different server pools in a server cluster, the plurality of server pools including an active pool and at least one standby pool, wherein machines in the active pool are machines that are available to be connected to clients in network sessions and wherein machines in the at least one standby pool are unavailable to be connected to clients in network sessions:
assigning a first set of machines to an active pool, wherein at least one of the first set of machines in the active pool operates as a stateful machine that is connected to at least one client in a lengthy and stateful session;
detecting a demand to update the first set of machines;
evaluating a status and capability of each of the first set of machines;
determining it is more appropriate to update the particular one or more of the first set of machines than a different one or more of the first set of machines based upon the status and capabilities of each of the first set of machines in the active pool;
moving the particular one or more of the first set of machines from the active pool to the at least one standby pool to be updated by at least:
enqueuing the particular one or more of the first set of machines in a queue to be moved from the active pool to the at least one standby pool; and
prior to dequeuing the one or more of the first set of machines to the at least one standby pool, performing a new validation that there is still an excess capacity of the first set of machines in the active pool, wherein whenever the active pool fails to have an excess capacity then moving another machine from the at least one standby pool to the active pool so that the active pool maintains excess capacity;
updating the particular one or more of the first set of machines in the at least one standby pool; and
subsequent to updating the particular one or more of the first set of machines, replacing the different one or more machines in the active pool with the particular one or more of the first set of machines.

20. A computing system composed of a plurality of different machines, each machine comprising a hardware processor and system memory, the computing system comprising:
an active server pool, the active server pool comprising a first set of one or more machines available to be connected to clients in network sessions, wherein at least one of the first set of machines in the active pool operates as a stateful machine that is connected to at least one client in a persistent and stateful session;
a first standby server pool, the first standby server pool comprising a second set of one or more machines that are configured to be moved into the active server pool and that are temporarily unavailable to be connected to clients in network sessions until being moved to the active server pool, the first standby server pool maintaining the second set of one or more machines in a first powered down or hibernation state; and
a second standby server pool, the second standby server pool comprising a third set of one or more machines that are configured to be moved into the active server pool or the first standby server pool, the third set of one or more machines being temporarily unavailable to be connected to clients in network sessions until being moved to the active server pool, the second standby server pool maintaining the third set of one or more machines in a second powered down or hibernation state that is different than the first powered down or hibernation state.
